(19) United States
(12) Patent Application Publication
(10) Pub. No.: US 2013/0286321 A1
(43) Pub. Date: Oct. 31, 2013

(54) LCD Device and Backlight Module

(71) Applicants: Yicheng Kuo, Shenzhen (CN); Shihhsiang Chen, Shenzhen (CN); Gang Yu, Shenzhen (CN); Gege Zhou, Shenzhen (CN); Jiaqiang Wang, Shenzhen (CN)

(72) Inventors: Yicheng Kuo, Shenzhen (CN); Shihhsiang Chen, Shenzhen (CN); Gang Yu, Shenzhen (CN); Gege Zhou, Shenzhen (CN); Jiaqiang Wang, Shenzhen (CN)

(21) Appl. No.: 13/515,527

(22) PCT Filed: May 9, 2012
(86) PCT No.: PCT/CN2012/075249

§ 371 Date: Jun. 13, 2012

(30) Foreign Application Priority Data
Apr. 28, 2012 (CN) 201210132850.8

(51) Int. Cl. G02F 1/13357

(52) U.S. Cl. 349/58; 312/223.5

(57) ABSTRACT

The invention relates to the field of LCDs, and more particularly to an LCD device and a backlight module. The LCD device includes a middle frame, a backplane, and an LCD panel; the LCD panel is arranged on a support surface of the middle frame; the middle frame includes a plurality of member units, and a distance is reserved between two adjacent member units. The LCD device further comprises a support member(s) used for assistantly supporting the LCD panel; the support member(s) is fixedly arranged on the backplane, and the support member is positioned between adjacent member units; the support surface of the support member is flush with the support surface of the middle frame. The support member(s) of the LCD panel is additionally arranged on the LCD device of the invention; the support member(s) is arranged between two member units when the distance between two adjacent member units is long to provide intermediate support force, so as to enable the support force obtained by the LCD panel is more uniform, and prevent excessive local stress.

### TECHNICAL FIELD

The invention relates to the field of liquid crystal displays (LCDs), and more particularly to an LCD device and a backlight module.

### BACKGROUND

A conventional LCD device generally includes a front frame, an LCD panel, a middle frame, a backlight module, a back cover and the like. The backlight module includes an optical film, a light guide panel (LGP), a lightbar and the like. The front frame, the middle frame and the back cover respectively have different functions; the front frame is mainly used for fixing the LCD panel and preventing the LCD panel from escaping, the middle frame is mainly used for bearing the LCD panel and shielding partial backlight module from light leakage, and the back cover is mainly used for bearing the optical film, the LGP, the lightbar and the like and ensuring the planeness of the backlight module.

To save cost, a part of LCD devices employ a segmented middle frame. The middle frame includes a plurality of member units; the member units are respectively fixed on the backplane or the front frame, and a distance is reserved between every two member units. The same member units are applied to the LCD devices of various sizes; thus, the material is reduced to be used, and the development cost and cycle of LCD devices are reduced.

Because the middle frame is of a segmented structure, the support surface of the middle frame is also discontinuous; thus, the support force applied to the LCD panel is nonuniform. When the distance between two adjacent member units of the LCD device is long, the planeness of the LCD panel is affected to some extent, and excessive local stress is easily generated on the LCD panel. The LCD panel includes thin glass substrate(s) which is hard and fragile, and the glass substrate is easily damaged because of stress concentration, resulting in adverse effect on the quality of the whole LCD device.

### SUMMARY

In view of the above-described technical problems, the aim of the invention is to provide an LCD device and a backlight module with a segmented middle frame and low cost. The LCD device and the backlight module can ensure that the support force applied to the LCD panel is uniform, and avoid excessive local stress.

A first technical scheme of the invention is that: an LCD device comprises a middle frame, a backplane, and an LCD panel; the LCD panel is arranged on a support surface of the middle frame; the middle frame comprises a plurality of member units, and a distance is reserved between two adjacent member units. The LCD device further comprises a support member(s) used for assistantly supporting the LCD panel; the support member(s) is fixedly arranged on the backplane, and the support member is positioned between two adjacent member units. A support surface of the support member is flush with the support surface of the middle frame. The support member is a rivet bolt and is riveted on a bottom plate of the backplane. The top surface of the rivet bolt is a support surface, and the support surface of the rivet bolt is a plane. The width of the support surface of the support member is less than or equal to that of the support surface of the middle frame. The member units are frame corner members, and are distributed on the four corners of the backplane. The number of the support members arranged between part of adjacent member units is multiple.

A second technical scheme of the invention is that: an LCD device comprises a middle frame, a backplane, and an LCD panel; the LCD panel is arranged on a support surface of the middle frame; the middle frame comprises a plurality of member units, and a distance is reserved between two adjacent member units. The LCD device further comprises a support member(s) used for assistantly supporting the LCD panel; the support member(s) is fixedly arranged on the backplane, and the support member is positioned between two adjacent member units. The support surface of the support member is flush with the support surface of the middle frame.

Preferably, the support member is a rivet bolt and is riveted on the bottom plate of the backplane, and the top surface of the rivet bolt is a support surface.

Preferably, the support member is a rivet bolt and is riveted on one side wall of the backplane.

Preferably, the support surface of the rivet bolt is a plane. The plane can better provide support for the LCD panel, to avoid the adverse effect of point contact and line contact on the LCD panel.

Preferably, the width of the support surface of the support member is less than or equal to that of the support surface of the middle frame, to avoid blocking out the light emitted by the backlight module.

Preferably, the member units are frame corner members, and are distributed on the four corners of the backplane.

Preferably, the member units are frame edge members, and are distributed on the four edges of the backplane.

Preferably, the member units are frame corner members and frame edge members; the frame corner members are distributed on the four corners of the backplane, and the frame edge members are distributed on the four edges of the backplane.

Preferably, the number of the support members arranged between part of adjacent member units is multiple. Both the number and length of the support members can be purposefully set in accordance with the distance between two adjacent member units. However, the size of the support members is preferably unified into one specification, to facilitate management. When the distance between two adjacent member units is long, a plurality of support members are arranged; and when the distance between two adjacent member units is short, only one support member is arranged, or no support member is arranged.

A third technical scheme of the invention is that: a backlight module comprises a middle frame, and a backplane; the middle frame comprises a support surface used for supporting the LCD panel. The middle frame comprises a plurality of member units, and a distance is reserved between two adjacent member units. The backlight module further comprises a support member(s) used for assistantly supporting the LCD panel; the support member(s) is fixedly arranged on the backplane, and the support member is positioned between two adjacent member units. The support surface of the support member is flush with the support surface of the middle frame.

Preferably, the support member is a rivet bolt and is riveted on the bottom plate of the backplane, and the top surface of the rivet bolt is a support surface.

Preferably, the support member is a rivet bolt and is riveted on one side wall of the backplane.

Preferably, the support surface of the rivet bolt is a plane.

Preferably, the width of the support surface of the support member is less than or equal to that of the support surface of the middle frame.

Preferably, the member units are frame corner members, and are distributed on the four corners of the backplane.

Preferably, the member units are frame edge members, and are distributed on the four edges of the backplane.

Preferably, the member units are frame corner members and frame edge members; the frame corner members are distributed on the four corners of the backplane, and the frame edge members are distributed on the four edges of the backplane.

Preferably, the number of the support members arranged between part of adjacent member units is multiple.

In the invention, the direction of the support member parallel with the side wall of the backplane is the length direction, and the direction of the support member perpendicular to the side wall of the backplane is the width direction.

Advantages of the invention are summarized below: the support members of the LCD panel are additionally arranged on the LCD device of the invention; the support member(s) is arranged between two member units when the distance between two adjacent member units is long; the support surface of the support member is flush with the support surface of the middle frame to provide intermediate support force, so as to enable the support force obtained by the LCD panel is more uniform, and prevent excessive local stress.

### BRIEF DESCRIPTION OF FIGURES

FIG. 1 is a structure diagram of an LCD device of a first example of the invention;

FIG. 2 is an enlarged view of A shown in FIG. 1;

FIG. 3 is a structure diagram of an LCD device of a second example of the invention;

FIG. 4 is a structure diagram of an LCD device of a third example of the invention;

FIG. 5 is an enlarged view of B shown in FIG. 4;

FIG. 6 is a structure diagram of an LCD device of a fourth example of the invention;

FIG. 7 is an enlarged view of C shown in FIG. 6;

FIG. 8 is a structure diagram of an LCD device of a fifth example of the invention;

FIG. 9 is an enlarged view of D shown in FIG. 8;

FIG. 10 is a structure diagram of an LCD device of a sixth example of the invention; and

FIG. 11 is an enlarged view of E shown in FIG. 10.

Legends: 1. middle frame; 11. frame corner member; 12. frame edge member; 13. support surface; 2. backplane; 21. side wall; 22. bottom plate; 23. lug boss; 24. notch; 3. LCD panel; 4. support member; 41. support surface; 42. hook; 43. through hole.

### DETAILED DESCRIPTION

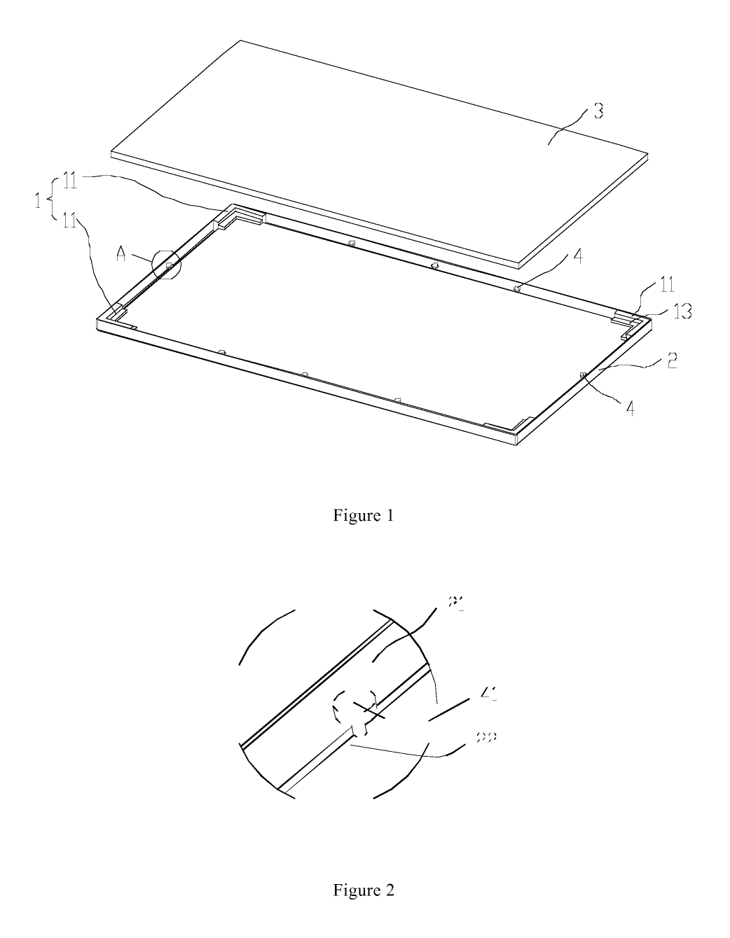

The invention provides an LCD device, comprising a backlight module; the backlight module comprises a middle frame 1, and a backplane 2. As shown in FIG. 1 and FIG. 2, the LCD device of a first example comprises a middle frame 1, a backplane 2, and an LCD panel 3; the LCD panel 3 is arranged on a support surface 13 of the middle frame 1; the middle frame 1 comprises a plurality of member units, and a distance is reserved between two adjacent member units. The backlight module further comprises a support member(s) 4 used for assistantly supporting the LCD panel 3; the support member(s) 4 is fixedly arranged on the backplane 2, and the support member 4 is positioned between two adjacent member units; a support surface 41 of the support member 4 is flush with the support surface 13 of the middle frame 1.

The support member(s) 4 of the LCD panel is additionally arranged on the LCD device of the invention, and the support member(s) 4 is arranged between two member units when the distance between two adjacent member units is long; the support surface 41 of the support member 4 is flush with the support surface 13 of the middle frame to provide intermediate support force, so as to enable the support force obtained by the LCD panel 3 is more uniform, and prevent excessive local stress.

In the example, the support member 4 is a rivet bolt and is riveted on a bottom plate 22 of the backplane. The top surface of the rivet bolt is the support surface 41, and the support surface 41 is a plane. The plane can better provide support for the LCD panel 3. The member units are four frame corner members 11, and are distributed on the four corners of the backplane 2. A distance is reserved between every two frame corner members 11. The distance of the middle frame 1 in the length direction is more than that in the width direction. In the example, the frame corner members 11 can be fixed on the backplane 2 by screws, fasteners, etc. The backplane 2 is provided with a plurality of support members 4 in the length direction, and is provided with one support member 4 in the width direction. The length or the total length of the support members 4 arranged between adjacent member units is less than the distance between adjacent member units; thus, the support members 4 are successfully arranged on the bottom plate 22 of the backplane. The width of the support surface of the support member 4 is less than or equal to that of the support surface 13 of the middle frame, to avoid blocking out the light emitted by the backlight module.

In the example, the rivet bolt can also be riveted on one side wall 21 of the backplane. However, the support surface of the rivet bolt should be a plane as far as possible, to avoid the adverse effect of point contact and line contact on the LCD panel.

In the example, the support members can also be bar-shaped blocks, round blocks, support bars, etc., and the support members can be fixed on the backplane by sticking, welding, etc.

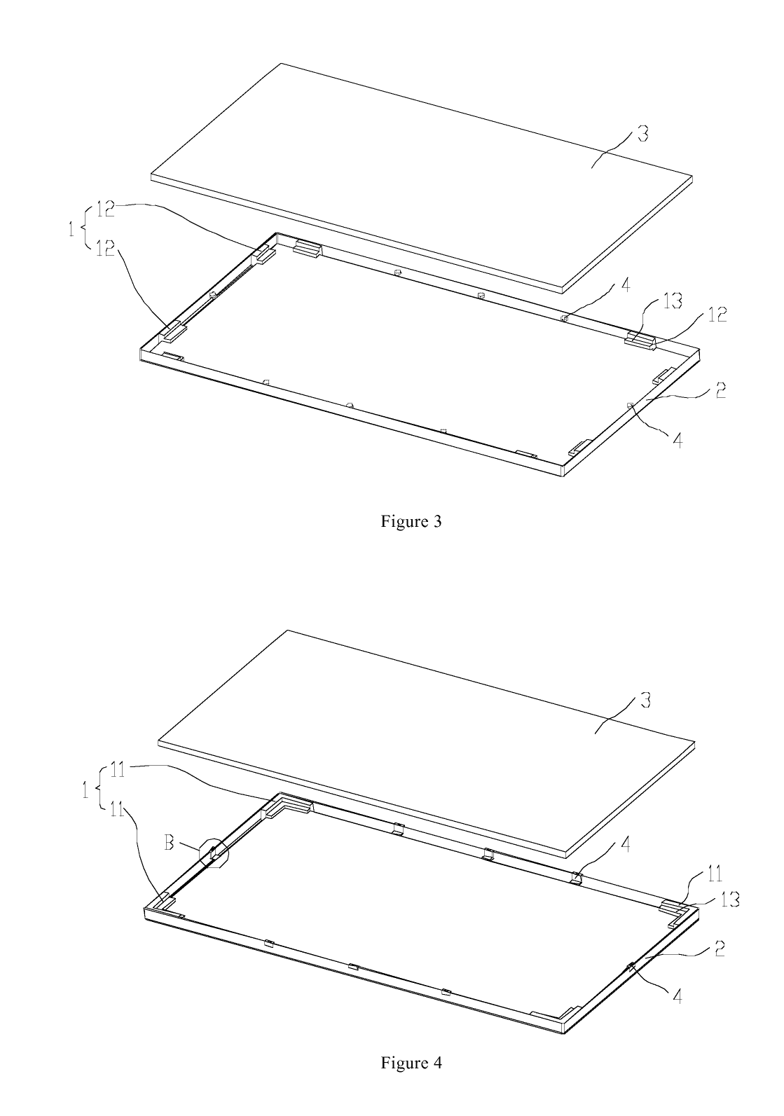

FIG. 3 shows a second example of the LCD device of the invention, and the second example is different from the first example in that: the member units are frame edge members 12, and are distributed on the four edges of the backplane 2; the structure of the support member 4 is consistent with that of the first example. In the example, the frame edge members are fixed on the backplane by screws, fasteners, etc. Alternatively, fixing columns are arranged on the frame edge members, and fixing holes are arranged in the side walls of the backplane. The fixing columns of the frame edge members are inserted in the fixing holes of the backplane; thus, the frame edge members are fixed on the backplane.

In the example, the support members can be arranged on the four corners of the backplane, to support the four corners of the LCD panel.

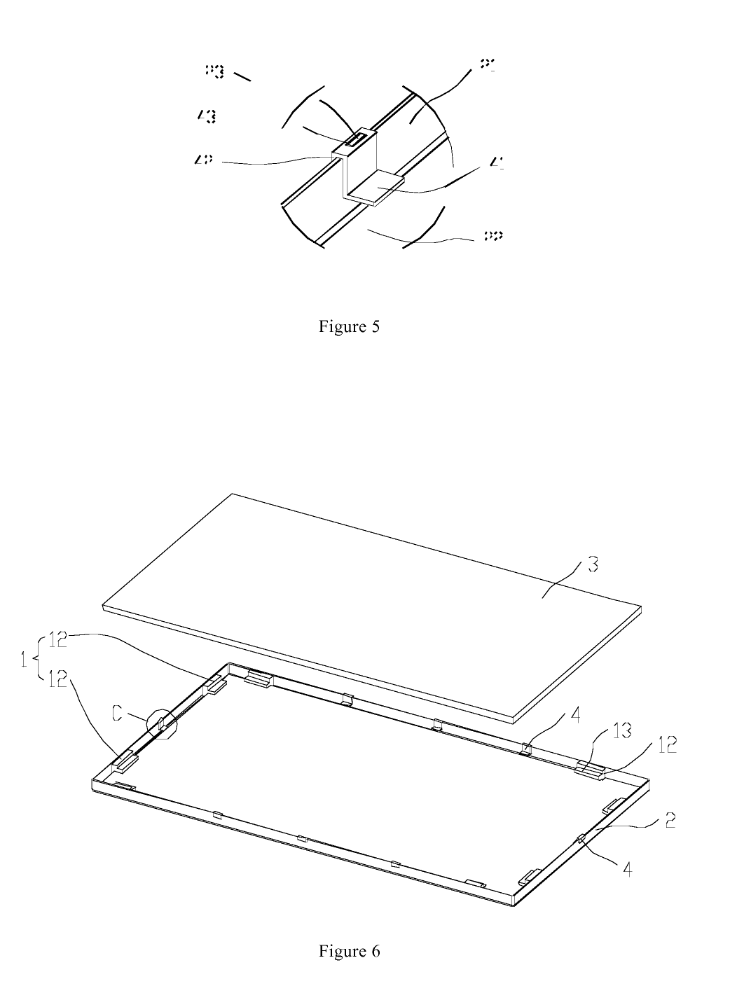

FIG. 4 and FIG. 5 show a third example of the LCD device of the invention, and the third example is different from the first example in that: the support member 4 is provided with a hook 42, and the support member 4 is hung on the side wall 21 of the backplane 2 by the hook 42. By being provided with the hook 41, the support member 4 is conveniently hung on the side wall 21 of the backplane, thereby saving time and effort during assembly.

In the example, the support member 4 is formed by bending a plate. The width of the hook 42 of the support member is equal to the length of the support member 4, thereby avoiding the inclination of the support member 4, to enable the support surface of the support member to be fully attached to the surface of the LCD panel.

In the example, the side wall 21 of the backplane is further provided with a positioning structure used for preventing the support member 4 from sliding on the side wall. The positioning structure comprises a through hole 43 arranged in the support member 4, and a lug boss 23 arranged on the upper end surface of the side wall of the backplane; the through hole 43 is sheathed on the lug boss 23. The positioning structure enables the support member 4 to have a fixed position, and then enables the LCD panel 3 to obtain reasonable support force in an appropriate position and not to be affected by the factors such as position error when being manually placed.

Optionally, the side wall of the backplane of the invention may be not provided with the positioning structure used for preventing the support member from sliding on the side wall. For example, interference fit exists between the hook of the support member and the side wall of the backplane, and then the support member is prevented from sliding by the friction between the hook and the side wall of the backplane.

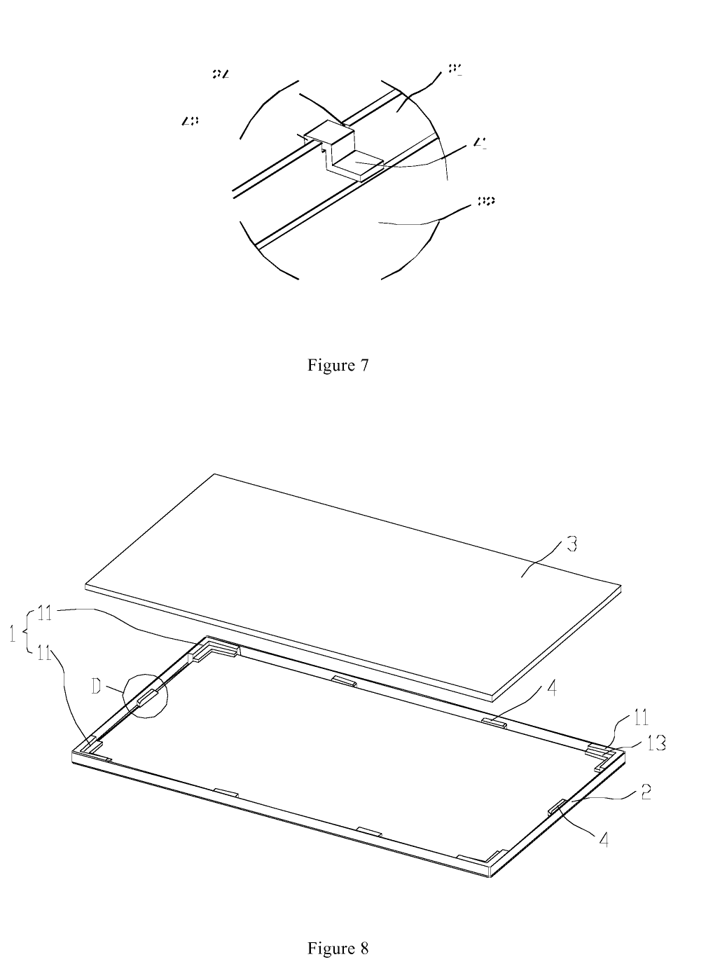

FIG. 6 and FIG. 7 show a fourth example of the LCD device of the invention, and the fourth example is different from the third example in that: the member units are frame edge members 12, and are distributed on the four edges of the backplane 2; the side wall 21 of the backplane is further provided with a positioning structure used for preventing the support member 4 from sliding on the side wall 21. The positioning structure comprises a notch 24 arranged in the side wall 21 of the backplane; the width of the notch 24 is longer than or equal to the length of the support member 4, and the support member 4 is limited in the notch 24. The function of the positioning structure of the example is consistent with that of the positioning structure of the third example.

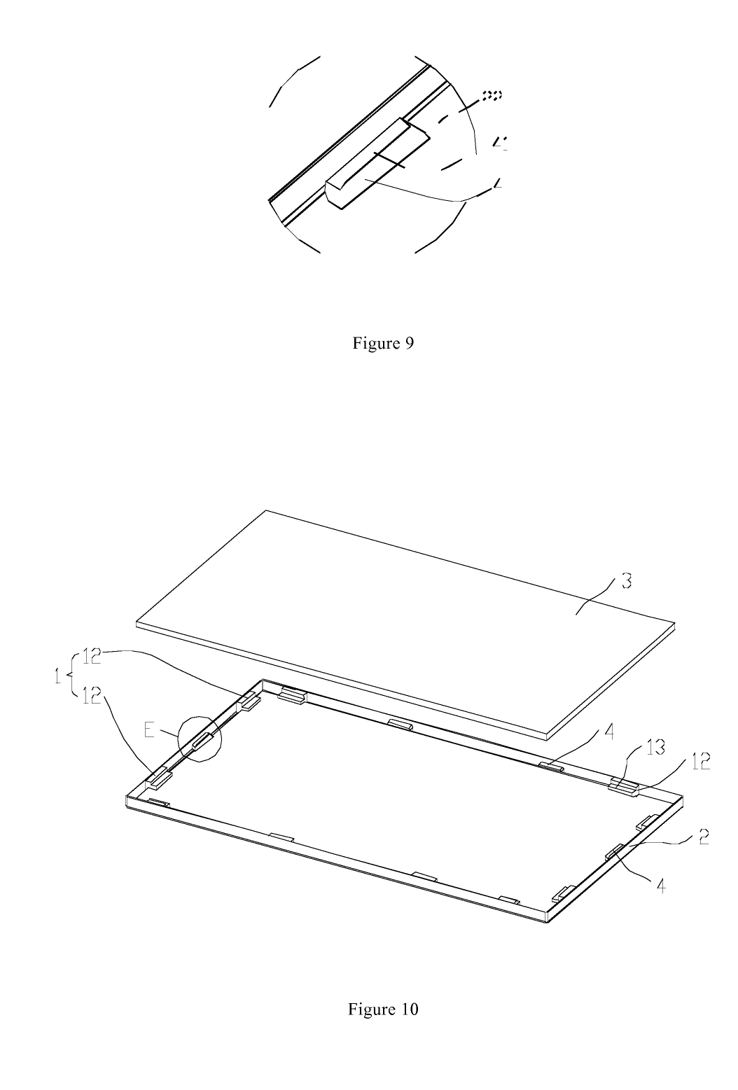

FIG. 8 and FIG. 9 show a fifth example of the LCD device of the invention, and the fifth example is different from the first example in that: the support member 4 is a protrusion arranged on the bottom plate 21 of the backplane 2; the protrusion comprises a support surface 41; the support surface 41 of the protrusion is flush with the support surface 13 of the middle frame.

In the example, the backplane 2 is locally punched to form the protrusion. The side walls of the protrusion are of a closed structure, and the support surface 41 of the protrusion is a plane. The protrusion does not add the material cost. The protrusion with side walls of a close structure has high strength, and can provide higher support force.

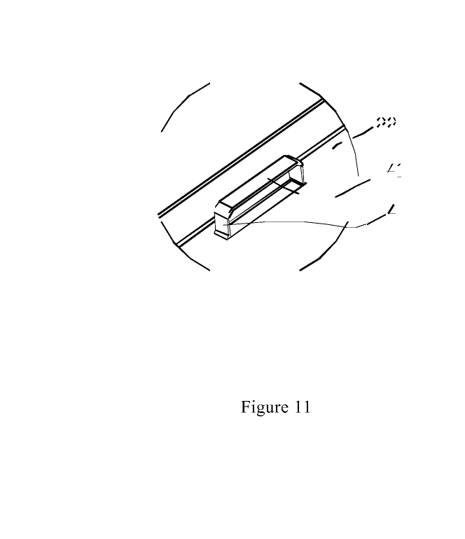

FIG. 10 and FIG. 11 show a sixth example of the LCD device of the invention, and the sixth example is different from the fifth example in that: the member units are frame edge members 12, and are distributed on the four edges of the backplane 2; the backplane 2 is locally punched to form the protrusion. Partial side walls of the protrusion are of an open structure. The protrusion is in a bent bar shape, and the protrusion does not add the material cost. The protrusion with side walls of an open structure has slightly low strength, but the height of the protrusion can be designed to be high. When the ductibility of the material of the backplane is slightly low, and the maximum height of the protrusion with side walls of a closed structure is still not high enough to be flush with the support surface of the middle frame, under the condition of ensuring that the material does not fracture, the scheme can be employed.

In the invention, both the number and length of the support members can be purposefully set in accordance with the distance between two adjacent member units. However, the size of the support members is preferably unified into one specification, to facilitate management. When the distance between two adjacent member units is long, a plurality of support members are arranged; when the distance between two adjacent member units is short, only one support member is arranged, or no support member is arranged.

In the invention, the member units can be frame corner members and frame edge members; the frame corner members are distributed on the four corners of the backplane, and the frame edge members are distributed on the four edges of the backplane. When the distance between two frame edge members or the distance between the frame edge member and the frame corner member is long, support members are appropriately arranged, to provide assistant support force for the LCD panel.

The invention is described in detail in accordance with the above contents with the specific preferred examples. However, this invention is not limited to the specific examples. For the ordinary technical personnel of the technical field of the invention, on the premise of keeping the conception of the invention, the technical personnel can also make simple deductions or replacements, and all of which should be considered to belong to the protection scope of the invention.

We claim:

1. An LCD device, comprising: a middle frame, a backplane, and an LCD panel; wherein said LCD panel is arranged on a support surface of said middle frame; said middle frame comprises a plurality of member units, and a distance is reserved between two adjacent member units; said LCD device further comprises a support member(s) used for assistantly supporting said LCD panel; said support member(s) is fixedly arranged on said backplane, and said support member is positioned between two adjacent member units; the support surface of said support member is flush with the support surface of said middle frame; said support member is a rivet bolt and is riveted on the bottom plate of said backplane, the top surface of said rivet bolt is a support surface, and the support surface of said rivet bolt is a plane; the width of the support surface of said support member is less than or equal to that of the support surface of said middle frame; said member units are frame corner members, and distributed on the four corners of said backplane; the number of said support members, arranged between said member units is multiple.

2. An LCD device, comprising: a middle frame, a backplane, and an LCD panel; wherein said LCD panel is arranged on a support surface of said middle frame; the middle frame comprises a plurality of member units, and a distance is reserved between two adjacent member units; said LCD device further comprises a support member(s) for assistantly supporting the LCD panel; said support member(s) is fixedly arranged on said backplane, and said support member is positioned between two adjacent member units; the support surface of said support member is flush with the support surface of said middle frame.

3. The LCD device of claim 2, wherein said support member is a rivet bolt and is riveted on the bottom plate of said backplane, and the top surface of said rivet bolt is the support surface.

4. The LCD device of claim 2, wherein said support member is a rivet bolt and is riveted on one side wall of said backplane.

5. The LCD device of claim 3, wherein the support surface of said rivet bolt is a plane.

6. The LCD device of claim 2, wherein the width of the support surface of said support member is less than or equal to that of the support surface of said middle frame.

7. The LCD device of claim 2, wherein said member units are frame corner members, and are distributed on the four corners of said backplane.

8. The LCD device of claim 2, wherein said member units are frame edge members, and are distributed on the four edges of said backplane.

9. The LCD device of claim 2, wherein said member units are frame corner members and frame edge members; said frame corner members are distributed on the four corners of said backplane, and said frame edge members are distributed on the four edges of said backplane.

10. The LCD device of claim 2, wherein the number of said support members arranged between adjacent member units is multiple.

11. A backlight module, comprising: a middle frame, and a backplane; wherein said middle frame comprises a support surface used for supporting said LCD panel; said middle frame comprises a plurality of member units, and a distance is reserved between two adjacent member units; said backlight module further comprises a support member(s) used for assistantly supporting said LCD panel; said support member(s) is fixedly arranged on said backplane, and said support member is positioned two adjacent member units; the support surface of said support member is flush with the support surface of said middle frame.

12. The backlight module of claim 11, wherein said support member is a rivet bolt and is riveted on the bottom plate of said backplane, and the top surface of said rivet bolt is a plane.

13. The backlight module of claim 11, wherein said support member is a rivet bolt and is riveted on one side wall of said backplane.

14. The backlight module of claim 12, wherein the top surface of said rivet bolt is a plane.

15. The backlight module of claim 11, wherein the width of the support surface of said support member is less than or equal to that of the support surface of said middle frame.

16. The backlight module of claim 11, wherein said member units are frame corner members, and are distributed on the four corners of said backplane.

17. The backlight module of claim 11, wherein said member units are frame edge members, and are distributed on the four edges of said backplane.

18. The backlight module of claim 11, wherein said member units are frame corner members and frame edge members; said frame corner members are distributed at the four corners of said backplane, and said frame edge members are distributed on the four edges of said backplane.

19. The backlight module of claim 11, wherein the number of said support members arranged between part of adjacent member units is multiple.
